(19) United States
(12) Patent Application Publication
(10) Pub. No.: US 2025/0172667 A1
(43) Pub. Date: May 29, 2025

(54) PROCESSING OF DATA ACQUIRED BY A LIDAR SENSOR

(71) Applicant: Continental Autonomous Mobility Germany GmbH, Ingolstadt (DE)

(72) Inventors: Boris LUGEZ, Toulouse (FR); Hamed SAMIE, Pins Justaret (FR); Niklas PETTERSSON, Tournefeuille (FR)

(73) Assignee: Continental Autonomous Mobility Germany GmbH, Ingolstadt (DE)

(21) Appl. No.: 18/937,317

(22) Filed: Nov. 5, 2024

(30) Foreign Application Priority Data
Nov. 24, 2023 (FR) FR2313042

(51) Int. Cl. G01S 7/48; G01S 17/894; G01S 17/931; G06T 7/73; G06V 10/26; G06V 20/56

(52) U.S. Cl. CPC G01S 7/4808; G01S 17/894; G01S 17/931; G06T 7/73; G06V 10/26; G06V 20/56; G06T 2207/10028; G06T 2207/30252

(57) ABSTRACT

Examples set out a method of processing data acquired by a LiDAR sensor, a computer configured to carry out this processing, a vehicle carrying a computer thus configured, a computer program product, and a computer-readable non-transitory storage medium.

### CROSS REFERENCE TO RELATED APPLICATIONS

This application claims priority to French Patent Application No. 2313042, filed Nov. 24, 2023, the contents of such applications being incorporated by reference herein.

### FIELD OF THE INVENTION

The present disclosure relates to the field of data processing.

### BACKGROUND OF THE INVENTION

The processing of data acquired by sensors is increasingly used in real time to evaluate situations and make decisions regarding these situations.

For example, there are methods for tracking, in real time, features of an object that are identified over a sequence of images acquired by a camera so as to estimate a relative movement of the object with respect to the camera, which can notably make it possible to anticipate the movement of the object.

These methods are extremely useful, notably in the context of driver assistance functions or autonomous driving functions, since they make it possible to track, in real time, the motor vehicles surrounding the vehicle on which the cameras are mounted and possibly to anticipate the trajectory of these vehicles.

However, the methods of tracking the features of an object can be improved.

### SUMMARY OF THE INVENTION

In this regard, a method, implemented by a computer, of processing data acquired by a LiDAR sensor is proposed, the method comprising:
obtaining a first matrix of points and a second matrix of points using acquisitions by a LiDAR sensor, the points of the first matrix and of the second matrix representing the environment of the LiDAR sensor at a first instant and at a second instant, respectively; each point of the matrices of points being associated with coordinates in a three-dimensional space and with an intensity value;
projecting the matrices of points onto a two-dimensional projection plane to obtain, for each of the matrices, an intensity image and a depth image;
for each of the first and second matrices of points:
determining at least one feature belonging to an element of the environment of the LiDAR sensor on the matrix of points, using the three-dimensional coordinates and the intensity values of the points of the matrix of points, a feature thus being associated with a point of the matrix; then for at least one determined feature on each matrix:
determining, in the intensity image, a first window of neighboring points that is related to the feature and comprises the point associated with the feature, using the two-dimensional coordinates of the points of the matrix and the intensity values of said points in the intensity image;
determining a second window of neighboring points that is related to the feature, the neighboring points of the second window of neighboring points corresponding to the neighboring points of the first window of neighboring points that are at a distance from the point representing the feature below a predetermined threshold in the three-dimensional space or in the depth image; then
comparing a second window of neighboring points of the first matrix of points with a second window of neighboring points of the second matrix of points; then
associating a feature related to a second window of neighboring points of the first matrix of points with a corresponding feature related to a second window of neighboring points of the second matrix of points using the comparison.

Optionally, the method may further comprise determining a displacement of the feature belonging to the element of the environment of the LiDAR sensor between the first instant and the second instant, using the two second windows of neighboring points related to the corresponding associated features.

Optionally, determining a displacement of the feature belonging to the element of the environment of the LiDAR sensor between the first instant and the second instant may comprise:
determining a two-dimensional displacement of the feature between the first instant and the second instant, in the intensity image, using the two-dimensional coordinates and the intensity values of the points of the two second windows of points associated with the feature in the intensity image; and
determining a three-dimensional displacement of the feature between the first instant and the second instant, using the two-dimensional displacement in the intensity image, and using the two-dimensional coordinates and the depth values of the points of the two second windows of points associated with the feature in the depth image.

Optionally, the method may also comprise for a second window of neighboring points that is related to a feature:
determining a descriptor of the second window of neighboring points, a descriptor corresponding to a characteristic value of the window of neighboring points that is determined using the coordinates and the intensity values of the points of the second window of points in the intensity image; and
   a feature related to a second window of neighboring points of the first matrix of points may be associated with a corresponding feature related to a second window of neighboring points of the second matrix of points using a distance between the descriptor associated with the second window of neighboring points of the first matrix and the descriptor associated with the second window of neighboring points of the second matrix.

Optionally, the operations of determining a descriptor of a second window of neighboring points and of associating a feature related to a second window of neighboring points of the first matrix of points with a corresponding feature related to a second window of neighboring points of the second matrix of points using a distance between the descriptors of these windows may be implemented using a binary robust independent elementary features method.

Optionally, the operations of determining a descriptor of a second window of neighboring points and of associating a feature related to a second window of neighboring points of the first matrix of points with a corresponding feature related to a second window of neighboring points of the second matrix of points may be implemented using a Lucas-Kanade method. In this option, the displacement of the feature of the element between the first instant and the second instant may be determined from a minimization of the distance between the descriptors of the two windows of neighboring points related to the corresponding associated features.

The application also relates to a computer configured to implement any of the data processing methods set out in the present disclosure, and to a vehicle carrying a computer having one of these configurations.

The application also relates to a computer program product comprising instructions for implementing any one of the methods set out in the present disclosure when this program is executed by a processor.

Finally, the application relates to a computer-readable non-transitory storage medium on which is stored a program for implementing any one of the methods set out in the present disclosure when this program is executed by a processor.

The method according to the present disclosure therefore makes it possible, using information acquired using a LiDAR sensor, to track a feature of an element of the environment of the LiDAR sensor between two, or possibly more, matrices of points, to track a feature of the element of the environment of the LiDAR sensor over time. Thus, in applications in which the LiDAR sensor is carried on a motor vehicle, the tracked feature may for example belong to another motor vehicle so that motor vehicles traveling close to the vehicle carrying the LiDAR sensor can be tracked. Notably, the method makes it possible to track features over time, including in occlusion situations. Thus, optionally, the method can notably make it possible to determine a relative displacement of the feature over time.

### BRIEF DESCRIPTION OF THE DRAWINGS

Further features, details and advantages will become apparent from reading the detailed description below, and from analyzing the appended drawings, in which:

FIG. 1 schematically represents an example data processing device for implementing a method of processing data acquired by a LiDAR sensor.

FIG. 2 schematically represents an example vehicle comprising a data processing device and a LiDAR sensor.

FIG. 3 schematically represents an example of a method of processing data acquired by a LiDAR sensor.

FIG. 4 schematically represents an example of two matrices of points showing an occlusion situation.

### DETAILED DESCRIPTION OF EXEMPLARY EMBODIMENTS

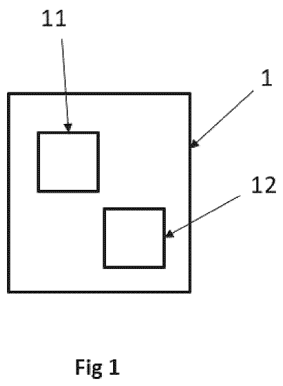

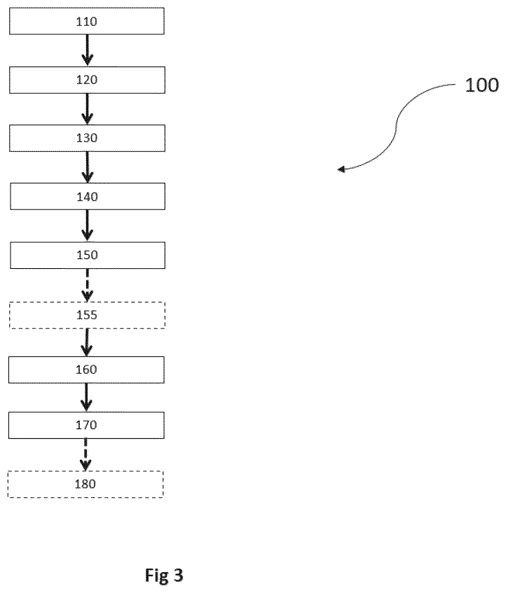

An example data processing device 1 for implementing a method of processing data acquired by a LiDAR sensor 10, and notably the example data processing method set out below with reference to FIG. 3, is described with reference to FIG. 1.

The data processing device 1 may be designed to be carried on a vehicle 2.

The data processing device 1 comprises a computer 11 and a memory 12. The device is configured to process data acquired by a light detection and ranging (LiDAR) sensor 10.

The memory 12 can store the code instructions executed by the computer 11 and used to control the acquisition of data by the LiDAR sensor 10, as well as the processing of said data. The computer 11 therefore has access to the information stored in memory. The memory 12 may also be designed to store the data acquired by the LiDAR sensor 10.

The memory 12 may for example be a read-only memory (ROM), a random-access memory (RAM), an electrically erasable programmable read-only memory (EEPROM) or any other suitable storage means. The memory may for example comprise optical, electronic or even magnetic storage means.

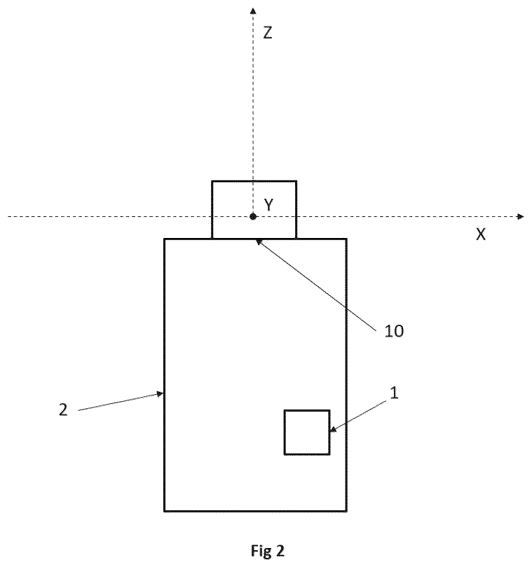

The data processing device 1 may be in a motor vehicle, as shown in the example in FIG. 2. This figure also shows a LiDAR sensor 10 enabling the acquisition of the data processed by the data processing device.

A light detection and ranging (LiDAR) sensor 10 is a sensor which emits light waves and determines, from the reflection of these light waves, a matrix of points representing an environment of the LiDAR sensor.

The LiDAR sensor 10 is designed to acquire matrices of points. Each point is associated with three-dimensional coordinates (x, y, z) representing the environment of the LiDAR sensor 10 and with an intensity value. With regard to the three-dimensional coordinates, the x-coordinate of a point is an abscissa coordinate of the point with respect to the sensor 10. The y-coordinate of a point is an ordinate coordinate of the point with respect to the sensor 10. The z-coordinate of a point is a depth coordinate of the point with respect to the LiDAR sensor 10. The example shown in FIG. 2 shows a top view of the outlines of the vehicle 2 and of the LiDAR sensor 10, and the abscissa axis X and depth axis Z of the LiDAR sensor 10. The ordinate axis Y of the sensor 10 is perpendicular to the axes X and Z. In the example shown in FIG. 2, the LiDAR sensor 10 is mounted at the front of the vehicle and is oriented to emit light beams in the direction of movement of the vehicle.

Each point acquired by the LiDAR sensor 10 is also associated with an intensity value. This is the intensity received by the LiDAR sensor after the light beam is reflected on a surface.

In first examples, the LiDAR sensor 10 according to the present disclosure may be a scanning LiDAR sensor. This is a LiDAR sensor that acquires a matrix of points representing its environment, in which each point of the matrix is associated with a different instant. More specifically, each point of the matrix of points is acquired by emitting a distinct light beam so that there is a time difference between the acquisition of each point of the matrix of points representing the environment of the LiDAR.

In second examples, the LiDAR sensor 10 according to the present disclosure may be a flash LiDAR sensor. Unlike the scanning LiDAR sensor, a flash LiDAR sensor acquires a matrix of points representing its environment by emitting a single light beam, of wide cross-section, so that each point of the matrix of points is acquired at the same instant.

An example method 100 of processing data acquired by a LiDAR sensor 10 is set out below with reference to FIG. 3. The method may for example be implemented by the computer 11 of the data processing device 1.

It should be noted that FIG. 3 is merely an illustration of the example of the method 100 using blocks to represent the various operations optionally included in the method and described below in the document. As such, this illustration does not reflect any sequentiality between the operations except where such sequentiality is specified in the present disclosure. In other words, the operations described with reference to FIG. 3 are not necessarily implemented one after the other and may be implemented in a different order from that shown in FIG. 3. Moreover, it is not necessary for each operation to be implemented once before a given operation is repeated a second time. The frequency of implementation of each operation is specific to itself, and is not necessarily related to implementation of the other operations.

As illustrated in FIG. 3, the method 100 comprises an operation 110 of obtaining a first matrix and a second matrix of points. These matrices of points are obtained from acquisitions by a LiDAR sensor 10. The points of the first and second matrices of points represent the environment of the LiDAR sensor at a first instant and at a second instant, respectively. As explained above, each point of the matrices of points is associated with a three-dimensional coordinate and an intensity value.

In the first examples, in which the LiDAR sensor 10 is a scanning LiDAR sensor, obtaining the first and second matrices of points may include correcting the three-dimensional coordinates of the points in each of these matrices to compensate for the time lag between the respective points in each matrix. Indeed, in examples in which the scanning LiDAR 10 moves during the acquisition of the points of a matrix, for example when it is mounted on a motor vehicle, the time lag between the acquisition of each point of the matrix will result in a lag in the three-dimensional coordinates of the points, which has to be corrected so that all of the points in a matrix are considered as acquired at one and the same instant. Methods for correcting this lag are known to a person skilled in the art. Notably, one method of correcting this lag is for example set out in the document by QIN et al. High-Precision Motion Compensation for LiDAR based on LiDAR Odometry.

Furthermore, it will be understood that this correction is not necessary in the second examples, in which the LiDAR sensor 10 is a flash LiDAR sensor, since the respective points of each of the matrices are acquired simultaneously. Indeed, the acquisition of two matrices of points at two different instants by a flash LiDAR sensor directly provides two matrices of points associated with two different instants.

As shown in FIG. 3, the method 100 then comprises an operation 120 of projecting the two matrices of points onto a two-dimensional projection plane to obtain, for each of the matrices, an intensity image and a depth image. An intensity image is an image comprising a plurality of points in a two-dimensional space, each point being associated with an intensity value. The depth image is an image comprising a plurality of points in a two-dimensional space, each point being associated with a depth value in this case. When the points in the matrices are projected into a two-dimensional space while retaining an intensity value for the intensity image and a depth value for the depth image, these points can also be called pixels of the intensity image and pixels of the depth image.

As illustrated in FIG. 3, the method 100 then comprises an operation 130, implemented on each of the first and second matrices, of determining at least one feature belonging to an element of the environment of the LiDAR sensor on the matrix of points so as to associate the feature with a point of the matrix. At least one feature is determined using the three-dimensional coordinates and the intensity values of the points.

The term “feature” in the present disclosure shall be understood to have the meaning used in the field of image processing, the image being in this case the considered matrix of points. In this field, the French term “caractéristique” usually corresponds to the English term “feature”. In this case, in the field of image processing, the term “feature” may refer to a visual attribute or a distinctive property of an image, such as outlines, textures, patterns, colors, shapes, angles, corners, etc.

In some examples, the operation 130 of determining at least one feature belonging to an element of the environment of the LiDAR sensor on a considered matrix of points may comprise determining at least one of an outline, a texture, a pattern, a color, a shape, an angle or a corner of an element of the environment of the LiDAR sensor.

In some examples, the operation 130 of determining at least one feature belonging to an element of the environment of the LiDAR sensor on the matrix of points may comprise an angle of a vehicle.

The determined feature on the matrix of points is associated with a point of the considered matrix of points. In examples in which the determined feature is included in several points of the matrix of points, the point of the matrix of points that is associated with the feature is chosen from points comprising a subset of the determined feature. In examples in which the determined feature is included in a single point of the matrix of points, the point of the matrix of points that is associated with the feature corresponds to the point comprising the feature.

In some examples, a feature of an element of the environment of the LiDAR sensor 10 is determined on a matrix of points using an intensity gradient.

As illustrated in FIG. 3, the method 100 then comprises an operation 140, implemented for at least one determined feature on each matrix. Advantageously, the operation 140 is implemented on each feature determined on the first matrix and on the second matrix during the operation 130.

The operation 140 is carried out in the intensity image of the matrix. It involves determining a first window of neighboring points that is related to a considered feature of the matrix, and comprising the point associated with the feature in the intensity image. The first window of neighboring points is determined using the two-dimensional coordinates of the points of the matrix and the intensity values of said points in the intensity image. In this case, when a feature is determined on a matrix during the operation 130 and is associated with a given point of the matrix, it is entirely possible to track this point projected onto the intensity image and/or depth image. This makes it possible to determine a first window of neighboring points, in the intensity image, comprising this point associated with the feature. A window of neighboring points, as the name suggests, comprises a plurality of points positioned next to each other in the two-dimensional space of the image on which it is determined.

In some examples, the first window of neighboring points that is related to a specific feature may include the point associated with the specific feature and the neighboring points of this point, i.e. the points at a distance below a predetermined distance threshold from the point associated with the specific feature. In these examples, the point associated with the specific feature may be a central point of the first window of neighboring points.

As illustrated in FIG. 3, the method 100 then comprises an operation 150 of determining a second window of neighboring points that is related to the feature. The neighboring points of the second window of neighboring points are the neighboring points of the first window of neighboring points that are at a distance from the point representing the feature below a predetermined threshold in the three-dimensional space or in the depth image. This operation involves removing points from the first window of neighboring points that are too far away from the point associated with the feature in the three-dimensional space or in the depth image to determine the second window of neighboring points. Indeed, since these points are too far from the point representing the feature in a space associated with a depth value, they could potentially belong to an element other than the element comprising the determined feature in the space. As described below, the method 100 makes it possible to track the displacement of a feature between two instants on the basis of the second windows of points associated with this feature at these two instants, i.e. the first instant being represented by the first matrix while the second instant is represented by the second matrix.

As illustrated in FIG. 3, the method 100 then comprises an operation 160 of comparing a second window of neighboring points belonging to the first matrix of points (at the first instant) with a second window of neighboring points belonging to the second matrix of points (at the second instant). The second windows of points are compared in the intensity image. Advantageously, each second window of neighboring points of the first matrix of points is respectively compared with each second window of neighboring points of the second matrix of points.

In some examples, the operation 160 of comparing a second window of neighboring points belonging to the first matrix of points with a second window of neighboring points belonging to the second matrix of points comprises determining a distance between the compared windows of neighboring points and comparing the distance between the compared windows of neighboring points. The distance used during this operation may notably be a Hamming distance.

As illustrated in FIG. 3, the method 100 comprises an operation 170 of associating a feature related to a second window of neighboring points of the first matrix of points with a corresponding feature related to a second window of neighboring points of the second matrix of points using the comparison. Thus, during the operation 170, a correspondence is established between a feature of the first matrix of points and a feature of the second matrix of points using the respective second windows of neighboring points of said points.

In some examples, a feature related to a second window of neighboring points of the first matrix of points is associated with a feature related to a second window of neighboring points of the second matrix of points if the distance between the respective windows of points of said points is below a predetermined threshold.

The method 100 according to the present disclosure therefore makes it possible, using information acquired using a LiDAR sensor 10, to track a feature of an element of the environment of the LiDAR sensor between two matrices of points. Although the method is set out for two matrices of points, it can be implemented on more than two matrices of points, in particular if they are acquired successively, in order to track a feature of the element of the environment of the LiDAR sensor 10 over time. Thus, in applications in which the LiDAR sensor 10 is carried on a motor vehicle, the tracked feature may for example belong to another motor vehicle so that motor vehicles traveling close to the vehicle carrying the LiDAR sensor 10 can be tracked, for example to estimate the speed of these motor vehicles or the respective trajectory thereof. Of course, many other applications can be envisaged and the present disclosure is not limited to automotive applications alone.

The feature is tracked, in the present disclosure, using information acquired by a LiDAR sensor 10. The LiDAR sensor 10 has the advantage, notably compared to a camera, of acquiring points having coordinates in a three-dimensional space. This means that feature tracking based on three-dimensional coordinates is more accurate than feature tracking based on two-dimensional coordinates.

The method 100, using the acquisition of data from the LiDAR sensor 10, for example also enables features to be tracked in occlusion situations. Occlusion situations are situations in which a feature being tracked, belonging to a first element of the environment of the sensor, is partially concealed or obscured by a second element of the environment of the sensor on a matrix of points. In these situations, defining a window of neighboring points that is related to the feature of the first element of the environment of the sensor in a matrix of points without taking account of any depth information of these points can make it difficult to track this feature, since such a window could include points belonging to the second element, distinct from the first element, in the environment of the sensor, this second element potentially moving relative to the first element. This impacts the association of corresponding features of two matrices of points based on a comparison of the windows of neighboring points related to these features, since a window of neighboring points of a first matrix of points representing the environment of the sensor at an instant t1 could comprise points belonging to the second element, while a window of neighboring points of a second matrix representing the environment of the sensor at an instant t2 will no longer include any such points if the second element has moved with respect to the first element between the instants t1 and t2. The method according to the present disclosure enables this type of situation to be managed notably by considering that the points determined in the second window of neighboring points are points close to the feature in the three-dimensional space or in the depth image (i.e. by taking account of depth information in this manner). This reduces the probability of some of the points making up the second window of neighboring points belonging to an element other than the element comprising the feature being tracked over time.

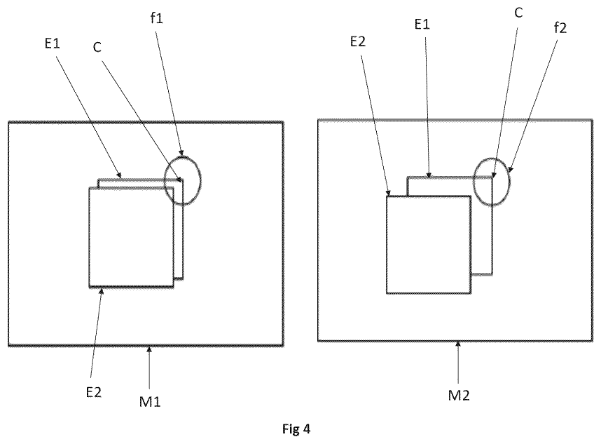

An example of an occlusion situation is notably illustrated schematically in FIG. 4, to facilitate understanding of this type of situation. This figure shows a first matrix of points M1 representing the environment of the camera at an instant t1 and a second matrix of points M2 representing the environment of the camera at an instant t2. On the first matrix of points M1, a first window of neighboring points f1 that is related to a feature C is shown schematically and comprises points belonging to a first element E1 and to a second element E2, partially concealing the first element E1. The first window of neighboring points f1 is related to a feature C belonging to the element E1. On the second matrix of points M2, a second window of neighboring points f2 that is also related to the feature C of the element E1 is shown schematically and comprises points belonging to the first element E1, but no longer comprises points belonging to the second element E2, since this element E2 has moved relative to the first element E1 between the acquisition of the first matrix M1 and the acquisition of the second matrix M2. It will be understood here that comparing the first window f1 with the second window f2 of neighboring points, if these neighboring points are considered in a two-dimensional coordinate space, will not make it possible to determine that the features C associated with the windows f1 and f2 are in fact corresponding features C of the element E1, since the points of the compared windows of neighboring points are relatively different. The method 100 according to the present disclosure precisely makes it possible to avoid this type of situation since the second windows of neighboring points compared during the operation 160 should no longer or almost no longer comprise points belonging to an element other than the element comprising the feature being tracked, since depth information is used to select the points of the second windows of points.

Other operations may optionally be incorporated into the method 100 and are set out in the remainder of the present disclosure. These operations can be incorporated into the method 100 in combination with each other, unless otherwise specified in the present disclosure.

In some examples, before the comparison operation 160, the method 100 may further comprise an operation 155 of determining, for each of the second windows of neighboring points compared during the operation 160, a descriptor corresponding to a characteristic value of the second window of neighboring points. An example of calculating a descriptor for a considered window of neighboring points is described notably in the document written by Calonder et al. BRIEF: Binary Robust Independent Elementary Features, incorporated herein by reference. The BRIEF document notably sets out a method known as the “Binary robust independent elementary features method” (BRIEF method).

In some examples, a descriptor of a second window of neighboring points can be determined using the two-dimensional coordinates and the intensity values of the points of the second window of neighboring points in the intensity image.

In examples in which a descriptor is determined for the windows of neighboring points compared during the operation 160, the operation 170 of associating a feature related to a second window of neighboring points of the first matrix of points with a corresponding feature related to a second window of neighboring points of the second matrix of points can be carried out using a distance between the descriptor associated with the second window of neighboring points of the first matrix and the descriptor associated with the second window of neighboring points of the second matrix, for example if a distance between the descriptor associated with the second window of neighboring points of the first matrix and the descriptor associated with the second window of neighboring points of the second matrix is below a predetermined distance threshold. The distance between the descriptors referred to here may for example be a Hamming distance.

In these examples, the operation 155 of determining a descriptor of a window of neighboring points and the operation 170 of associating a feature related to a window of neighboring points of the first matrix of points with a corresponding feature related to a window of neighboring points of the second matrix of points using a distance between the descriptors of these windows may be implemented using a binary robust independent elementary features method or using a Lucas-Kanade method.

In some examples, the method 100 may comprise an operation 180 of determining a displacement of the feature belonging to the element between the first instant and the second instant, using the two windows of neighboring points related to the associated features. Notably, by comparing the position of the second window of neighboring points on the second matrix of points with the position thereof on the first matrix of points and knowing the instant associated with each of the first and second matrices, it is possible to determine a displacement of the window of neighboring points between the first and second matrices of points, which corresponds to a displacement of the feature between the first instant and the second instant.

In some examples, the operation 180 of determining a displacement of the feature belonging to the element of the environment of the LiDAR sensor between the first instant and the second instant comprises:
determining a two-dimensional displacement of the feature between the first instant and the second instant, in the intensity image, using the two-dimensional coordinates and the intensity values of the points of the two second windows of points associated with the feature in the intensity image; and
determining a three-dimensional displacement of the feature between the first instant and the second instant, using the two-dimensional displacement in the intensity image, and using the two-dimensional coordinates and the depth values of the points of the two second windows of points associated with the feature in the depth image.

In examples comprising:
the operations of determining 155 a descriptor and of association 170 using a distance between the descriptors implemented using a Lucas-Kanade method; and
the operation 160 of determining a displacement of the feature belonging to the element between the first instant and the second instant, using the three-dimensional coordinates of the two windows of neighboring points related to the corresponding associated features, the displacement of the feature of the element between the first instant and the second instant may be determined from a minimization of the distance between the descriptors of the two windows of neighboring points related to the corresponding associated features.

These examples make it possible to determine a displacement of the feature between the two matrices on a scale smaller than that of a point of the matrices of points obtained from the acquisitions of the LiDAR sensor 10, so that the determined displacement is obtained in an extremely precise manner.

The method 100 according to the present disclosure therefore makes it possible, using information acquired using a LiDAR sensor 10, to track a feature of an element of the environment of the LiDAR sensor between two matrices of points, and optionally to determine a displacement of this feature between the two matrices. The method 100 is set out for two matrices of points, but can be implemented on more than two matrices of points in order to track a feature of the element of the environment of the LiDAR sensor 10 over time, and optionally to determine the displacement of this feature over time in an extremely precise manner.

1. A method, implemented by a computer, of processing data acquired by a LiDAR sensor, the method comprising:
obtaining a first matrix of points and a second matrix of points using acquisitions by a LiDAR sensor, the points of the first matrix and of the second matrix representing the environment of the LiDAR sensor at a first instant and at a second instant, respectively; each point of the matrices of points being associated with coordinates in a three-dimensional space and with an intensity value;
projecting the matrices of points onto a two-dimensional projection plane to obtain, for each of the matrices, an intensity image and a depth image;
for each of the first and second matrices of points:
determining at least one feature belonging to an element of the environment of the LiDAR sensor on the matrix of points, using the three-dimensional coordinates and the intensity values of the points of the matrix of points, a feature thus being associated with a point of the matrix; then
for at least one determined feature on each matrix:
determining, in the intensity image, a first window of neighboring points that is related to the feature and comprises the point associated with the feature, using the two-dimensional coordinates of the points of the matrix and the intensity values of said points in the intensity image;
determining a second window of neighboring points that is related to the feature, the neighboring points of the second window of neighboring points corresponding to the neighboring points of the first window of neighboring points that are at a distance from the point representing the feature below a predetermined threshold in the three-dimensional space or in the depth image; then
comparing a second window of neighboring points of the first matrix of points with a second window of neighboring points of the second matrix of points; then
associating a feature related to a second window of neighboring points of the first matrix of points with a corresponding feature related to a second window of neighboring points of the second matrix of points using the comparison.

2. The method as claimed in claim 1, further comprising:
determining a displacement of the feature belonging to the element of the environment of the LiDAR sensor between the first instant and the second instant, using the two second windows of neighboring points related to the corresponding associated features.

3. The method as claimed in claim 2, wherein determining a displacement of the feature belonging to the element of the environment of the LiDAR sensor between the first instant and the second instant comprises:
determining a two-dimensional displacement of the feature between the first instant and the second instant, in the intensity image, using the two-dimensional coordinates and the intensity values of the points of the two second windows of points associated with the feature in the intensity image; and
determining a three-dimensional displacement of the feature between the first instant and the second instant, using the two-dimensional displacement in the intensity image, and using the two-dimensional coordinates and the depth values of the points of the two second windows of points associated with the feature in the depth image.

4. The method as claimed in claim 1, further comprising, for a second window of neighboring points that is related to a feature, determining a descriptor of the second window of neighboring points, a descriptor corresponding to a characteristic value of the window of neighboring points that is determined using the coordinates and the intensity values of the points of the second window of points in the intensity image; and
wherein a feature related to a second window of neighboring points of the first matrix of points is associated with a corresponding feature related to a second window of neighboring points of the second matrix of points using a distance between the descriptor associated with the second window of neighboring points of the first matrix and the descriptor associated with the second window of neighboring points of the second matrix.

5. The method as claimed in claim 4, wherein the determination of a descriptor of a second window of neighboring points and the association of a feature related to a second window of neighboring points of the first matrix of points with a corresponding feature related to a second window of neighboring points of the second matrix of points using a distance between the descriptors of these windows are implemented using a binary robust independent elementary features method.

6. The method as claimed in claim 4, further comprising determining a displacement of the feature belonging to the element of the environment of the LiDAR sensor between the first instant and the second instant, using the two second windows of neighboring points related to the corresponding associated features,
wherein the determination of a descriptor of a second window of neighboring points and the association of a feature related to a second window of neighboring points of the first matrix of points with a corresponding feature related to a second window of neighboring points of the second matrix of points are implemented using a Lucas-Kanade method; and
wherein the displacement of the feature of the element between the first instant and the second instant is determined from a minimization of the distance between the descriptors of the two windows of neighboring points related to the corresponding associated features.

7. A computer program product including instructions for implementing any one of the methods as claimed in claim 1 when this program is executed by a processor.

8. A computer-readable non-transitory storage medium on which is stored a program for implementing any one of the methods as claimed in claim 1.

9. A computer configured to implement a method as claimed in claim 1.

10. A motor vehicle comprising a computer as claimed claim 9.
